(19) United States
(12) Patent Application Publication
(10) Pub. No.: US 2014/0172438 A1
(43) Pub. Date: Jun. 19, 2014

(54) MOBILE APPLICATION PLATFORM ALLOWING DOCTORS TO SIGN OUT TO EACH OTHER REGARDING THEIR PATIENTS

(71) Applicant: Kurian Thott, Stafford, VA (US)

(72) Inventor: Kurian Thott, Stafford, VA (US)

(21) Appl. No.: 13/715,789

(22) Filed: Dec. 14, 2012

(51) Int. Cl. G06F 19/00

(52) U.S. Cl. CPC G06F 19/327
USPC 705/2

(57) ABSTRACT

A mobile application platform allows physicians to access their patient census so that they can keep track of their patients during rounds, all on a mobile device via a mobile application. The application also allows physicians to keep track of their schedules, text one another, and allow cross coverage between multiple groups. The platform allows for seamless patient hand off between medical providers, enhancing safety of patient care.

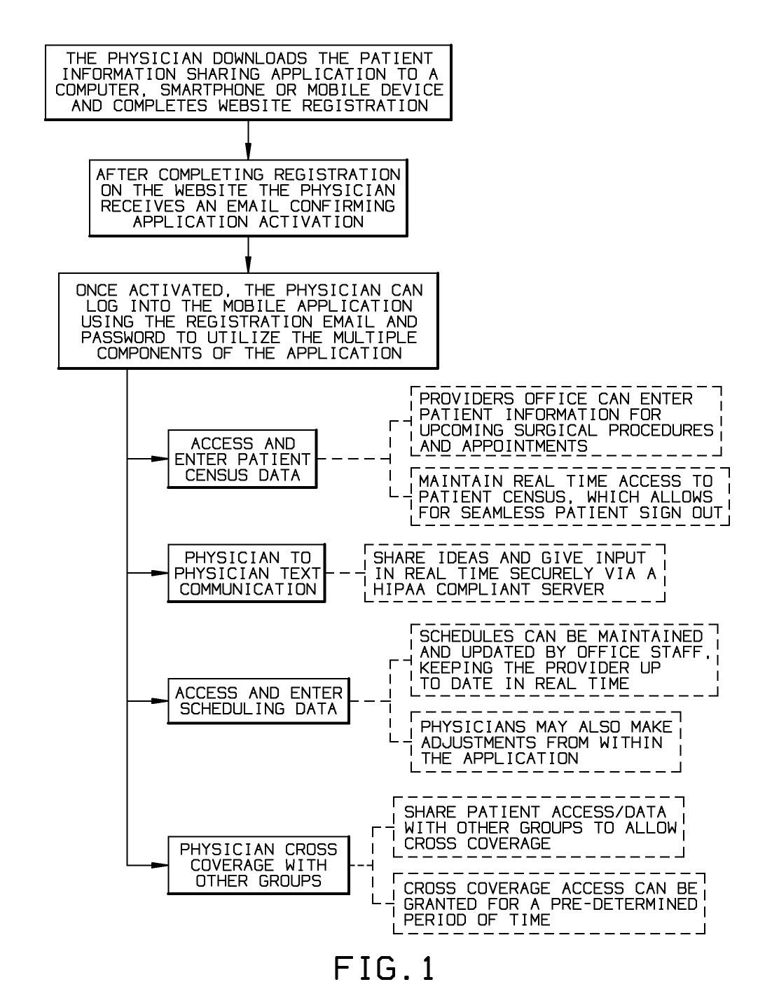

### BACKGROUND OF THE INVENTION

The present invention relates to mobile applications for physicians or their support staff and, more particularly, to a mobile application platform that allows doctors to sign out to each other regarding their patients.

Physicians are not able to efficiently communicate with one another in a secure manner. There are currently no systems that can effectively keep track of a patient schedule, physician on call schedule, allow physician-to-physician texting, allow cross coverage between multiple practices, and sign out current census of patients.

As can be seen, there is a need for a mobile application platform that can provide seamless communication between physicians while remaining HIPAA compliant.

### SUMMARY OF THE INVENTION

In one aspect of the present invention, a computer system comprises at least one database; at least one mobile device; and computer software, written on non-transient computer readable media and containing programming code operable to perform information sharing functions including accessing and entering patient census data in the database; permitting text messaging between physicians, each physician using at least one mobile device; accessing and entering scheduling data in the database; and granting cross coverage access with other groups.

In another aspect of the present invention, a mobile application is written on non-transient computer readable media and containing programming code and is operable to perform information sharing functions including accessing and entering patient census data in a database; permitting text messaging between physicians, each physician using one of the at least one mobile device; accessing and entering scheduling data in the database; and granting cross coverage access with other groups.

In a further aspect of the present invention, a computer system comprises at least one database residing on a server; at least one mobile device; and computer software, written on non-transient computer readable media and containing programming code operable to perform information sharing functions including accessing and entering patient census data in the database via a communication protocol; permitting text messaging between physicians, each physician using one of the at least one mobile device; accessing and entering scheduling data in the database; and granting cross coverage access with other groups.

These and other features, aspects and advantages of the present invention will become better understood with reference to the following drawings, description and claims.

### BRIEF DESCRIPTION OF THE DRAWING

The FIGURE is a flow chart describing use of a mobile application according to an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a mobile application platform that allows physicians to access their patient census so that they can keep track of their patients during rounds, all on a mobile device via a mobile application. The application also allows physicians to keep track of their schedules, text one another, and allow cross coverage between multiple groups. The platform allows for seamless patient hand off between medical providers, enhancing safety of patient care.

The platform of the present invention includes a mobile application designed to perform various functions on a mobile device. The mobile device can be any mobile device capable of running the mobile application. Examples of such mobile devices include smartphones, tablet computers, laptop computers and the like. The platform of the present invention further includes a database for storing information about the patients, information related to the physicians, and the like. The database can reside on a computer system, such as a server, and can be accessed via various information communication protocols, such as via the internet, via a wireless network, or the like. Typically, the information communication protocol will synchronize each of the mobile devices of the platform when information is updated on any of the mobile devices, or on a stationary device (such as a desktop computer or the like) that has access to the database.

Referring now to the FIGURE, to begin use of the application, the physician can download the patient information sharing application to a computer, smartphone, tablet computer, or some other mobile device. The physician can complete a website registration. After completing the registration, a confirmation email can be sent to the physician to confirm enrollment. Once activated, the physician can log into the mobile application using the registration email and password to utilize the multiple components of the application.

As new information is received into the database, the system of the present invention can synchronize this information with each of the registered users. The mobile application and the website can be synchronized with patient demographic information, which can be entered either through a website interface or on the mobile application. Patients can be admitted or discharged from the mobile application and that information can be reflected on the website.

The mobile application of the present invention, as well as the internet interface, can provide various functions for the physician. For example, the physician can access and enter patient census data. This data can include patient information for upcoming surgical procedures and appointments, for example. This data can be maintained in real time, providing physicians with up to date patient information and allowing for seamless patient sign out.

The mobile application of the present invention can include a feature to permit physician-to-physician text communication. This can allow physicians to share ideas and give input in real time, securely via a HIPAA compliant server.

The mobile application of the present invention can include a feature to allow access to and permit entry of scheduling data. Schedules can be maintained and updated by office staff, keeping the provider up to date in real time. Physicians can also access the scheduling data to make adjustments from within the application.

The mobile application of the present invention can also allow for physician cross coverage with other groups. This feature can permit sharing of patient access/data with other groups to allow for cross coverage. This cross coverage access can be granted for a pre-determined period of time, if desired.

It should be understood, of course, that the foregoing relates to exemplary embodiments of the invention and that modifications may be made without departing from the spirit and scope of the invention as set forth in the following claims.

What is claimed is:

1. A computer system comprising:
at least one database;
at least one mobile device; and
computer software, written on non-transient computer readable media and containing programming code operable to perform information sharing functions including:
accessing and entering patient census data in the database;
permitting text messaging between physicians, each physician using one of the at least one mobile device;
accessing and entering scheduling data in the database; and
granting cross coverage access with other groups.

2. The computer system of claim 1, wherein the database resides on a server accessible via one or more communication protocols.

3. The computer system of claim 2, wherein the one or more communication protocols include internet access.

4. The computer system of claim 1, wherein the at least one mobile device includes at least one of a smartphone and a tablet computer.

5. The computer system of claim 1, further comprising an internet-based interface permitting access to the database via an internet connection.

6. A mobile application, written on non-transient computer readable media and containing programming code operable to perform information sharing functions including:
accessing and entering patient census data in a database;
permitting text messaging between physicians, each physician using one of the at least one mobile device;
accessing and entering scheduling data in the database; and
granting cross coverage access with other groups.

7. The mobile application of claim 6, further comprising registering the physician to access the information sharing functions.

8. The mobile application of claim 7, further comprising confirming registration of the physician via a confirmation email.

9. A computer system comprising:
at least one database residing on a server;
at least one mobile device; and
computer software, written on non-transient computer readable media and containing programming code operable to perform information sharing functions including:
accessing and entering patient census data in the database via a communication protocol;
permitting text messaging between physicians, each physician using one of the at least one mobile device;
accessing and entering scheduling data in the database; and
granting cross coverage access with other groups.

10. The computer system of claim 9, wherein the communication protocol includes internet access.

11. The computer system of claim 9, wherein the at least one mobile device includes at least one of a smartphone and a tablet computer.

12. The computer system of claim 9, further comprising an internet-based interface permitting access to the database via an internet connection.
